(19) United States
(12) Patent Application Publication
(10) Pub. No.: US 2022/0380104 A1
(43) Pub. Date: Dec. 1, 2022

(54) ELECTROSCOPIC MATERIAL PACKAGING

(71) Applicant: CoCreateX, Saint Paul, MN (US)

(72) Inventor: Nicholas Powley, Saint Paul, MN (US)

(21) Appl. No.: 17/569,162

(22) Filed: Jan. 5, 2022

Related U.S. Application Data
(60) Provisional application No. 63/134,003, filed on Jan. 5, 2021.

(51) Int. Cl. B65D 75/30; B65B 41/12; B65B 51/16; B65B 61/06; B65B 9/02; B01D 46/00

(52) U.S. Cl. CPC B65D 75/30; B65B 41/12; B65B 51/16; B65B 61/06; B65B 9/02; B01D 46/0098

(57) ABSTRACT

A method for producing enveloped electroscopic filter material can include feeding, from a main spool, at least one sheet of electroscopic filter material in a first direction, feeding, from a pair of spools, sheets of cover material in the first direction such that each spool feeds a sheet of cover material along a different side of the sheet electroscopic filter material, sealing, via a pair of heat-sealing roller nips, the at least one sheet of electroscopic filter material and the sheets of cover material periodically together to form sealed portions, and cutting, via a cutting mechanism, each sealed portion to produce envelopes of electroscopic filter material. The at least one sheet of electroscopic filter material can extend to the outermost edges of each envelope such that each envelope comprises substantially the same dimensions as the at least one sheet of electroscopic filter material.

### RELATED APPLICATION

The present application claims the benefit of U.S. Provisional Application No. 63/134,003 entitled “ELECTROSCOPIC MATERIAL PACKAGING”, filed Jan. 5, 2021, which is incorporated herein by reference in its entirety.

### BACKGROUND

Pandemic susceptibility is generally proportional to population and population density. Pandemic susceptibility is also proportional to virus mutation rates and the availability of effective vaccinations. Pandemic susceptibility of one species can be related to the pandemic susceptibility of other species. N95 masks that filter at least 95% of airborne particles are in great demand during pandemics. N95 masks require some form, and typically multiple actions of forming, folding, sealing, or molding. Packaging three (3) dimension (3D) articles is generally more expensive than packaging two (2) dimension (2D) articles. Packaging three (3) dimension (3D) articles is generally more expensive than packaging two (2) dimension (2D) articles. N95 masks are made from electroscopic material. The N95 property of N95 masks is attributable to the electroscopic property of N95 material.

Electroscopic material is currently sold in the form of jumbo, industrial-scale roles, granular material composites, large janitorial rolls, or in individual consumer packs consisting of some number, for example, six (6) or more unitary or frangibly separated partitions.

Electroscopic material is currently sold in the form of jumbo, industrial-scale roles, granular material composites, large janitorial rolls, or in individual consumer packs consisting of some number, for example, six (6) or more unitary or frangibly separated partitions; to purchase a package of one (1) unit would make little sense to the person managing his, her, or their household needs.

### SUMMARY

Electroscopic material is currently sold in the form of jumbo, industrial-scale roles, granular material composites, large janitorial rolls, or in individual consumer packs consisting of some number, for example, six (6) or more unitary or frangibly separated partitions; to purchase a package of one (1) unit would make little sense to the person managing his, her, or their household needs. It would further not make sense or be uniquely difficult for a person to adapt a frangible, perforated, fenestrated, or otherwise irreversibly prepared material segment into a personally protective filter. Described herein, is a package of filter material, electroscopic material, N95 material, N99 material, or other important filtration material, that contains one and only one continuous, substantially unfenestrated, piece of said material. Described herein, is a package of filter material, electroscopic material, N95 material, N99 material, or other important filtration material, that contains one and only one continuous, substantially unfenestrated, piece of said material, where optionally said single pieces of material is joined to or with itself. Described herein, is a package of packages of filter material, electroscopic material, N95 material, N99 material, or other important filtration material, that contains one and only one continuous, substantially unfenestrated, piece of said material. Described herein, is a package of filter material, electroscopic material, N95 material, N99 material, or other important filtration material, that contains one and only one continuous, substantially unfenestrated, piece of said material that is folded and sealed along its length. Described herein, is a package of filter material, electroscopic material, N95 material, N99 material, or other important filtration material, that contains one and only one continuous, substantially unfenestrated, piece of said material that is folded and sealed across its ends. Described herein, is a package of filter material, electroscopic material, N95 material, N99 material, or other important filtration material, that contains one and only one continuous, substantially unfenestrated, and that has no discernable end in at least one dimension. Described herein, is a package of filter material, electroscopic material, N95 material, N99 material, or other important filtration material, that contains one and only one continuous, substantially unfenestrated, and that has no discernable end in more than one dimension. Described herein, is a package of filter material, electroscopic material, N95 material, N99 material, or other important filtration material, that contains one and only one continuous, substantially unfenestrated, piece of said material, where the volume of the electroscopic material to be enveloped by the packaging is enveloped within a package that is spherically, cylindrically, planar, or otherwise naturally shaped to maximize the volume of the contents within the envelope. Described herein, is a package of filter material, electroscopic material, N95 material, N99 material, or other important filtration material, that contains one and only one continuous, substantially unfenestrated, piece of said material, where the volume of the electroscopic material to be enveloped by the packaging is enveloped within a package that is spherically, cylindrically, or otherwise naturally shaped to maximize the volume of the contents within the envelope, and where the article of the present disclosure draws its natural shape from the physical properties of the materials from which the contents and the envelope or package are composed and their processing together.

Pandemic susceptibility is generally inversely proportional to the availability of N95 material. N95 material is typically made by a first manufacturing process, where the first manufacturing process yields N95 material in a two (2) dimension (2D) web. Masks are typically made from the 2D N95 material web by a second manufacturing process, which typically includes some form and typically one or more actions of cutting, forming, folding, sealing, or molding, whereby the second manufacturing process yields a three (3) dimension (3D) article. Manufacturing masks requires both the first manufacturing process and the second manufacturing process. Packaging and distributing masks, that have undergone the second manufacturing process, is generally more expensive than packaging 2D segments of the 2D N95 web produced by the first manufacturing process even when including the cutting, stacking, and packing processes, minus re-rolling and storage. Packaging 2D N95 material segments produced by the first manufacturing process is less expensive than packaging 3D articles.

An object of the present disclosure is to provide as many conveniently packaged, individual or family packs of 2D N95 material, swatches, segments, or sections to the general public, as possible, to manage the person to person transmission of viruses that cause pandemics such as COVID-19. An object of the present disclosure is to provide as many conveniently packaged, individual family packs of 2D N95 material, swatches, segments, or sections to the general public, as possible, to manage the person to person transmission of COVID-19, where the swatch, segment, or section is singular within the package. An object of the present disclosure is to provide as many conveniently packaged, individual family packs of 2D N95 material, swatches, segments, or sections to the general public, as possible, to manage the person to person transmission of COVID-19, where the swatches, segments, or sections are singular within the package and separated by perforations so that the swatches segments or sections can be separated. An object of the present disclosure is to provide as many conveniently packaged, individual family packs of 2D N95 material, swatches, segments, or sections to the general public, as possible, to manage the person to person transmission of COVID-19, where the swatches, segments, or sections are singular within the package and separated by blind slits so that the swatches segments or sections can be separated and continue to provide filtration if not separated. An object of the present disclosure is to provide as many conveniently packaged, individual family packs of 2D N95 material, swatches, segments, or sections to the general public, as possible, to manage the person to person transmission of COVID-19, where the swatches, segments, or sections are singular within the package and separated by patterned slits so that the swatches segments or sections can be separated and continue to provide filtration if not separated. An object of the present disclosure is to provide as many conveniently packaged, individual family packs of 2D N95 material, swatches, segments, or sections to the general public, as possible, to manage the person to person transmission of COVID-19, where the swatches, segments, or sections are singular within the package and separated by physical weaknesses so that the swatches segments or sections can be separated and continue to provide filtration if not separated. An object of the present disclosure is to provide as many conveniently packaged, individual family packs of 2D N95 material scarfs to the general public, as possible, to manage the person to person transmission of COVID-19, where the scarves are singular within the package and separated by physical weaknesses so that the swatches segments or sections can be separated and continue to provide filtration if not separated. An object of the present disclosure is to provide as many conveniently packaged, individual family packs of 2D N95 material scarfs to the general public, as possible, to manage the person to person transmission of COVID-19, where the scarves are separated within the package.

An object of the present disclosure is to provide a package including two pulse oximeters and a single piece of N95 material. An object of the present disclosure is to provide a package of packages each including two pulse oximeters and a single piece of N95 material. An object of the present disclosure is to provide a package including two or more pulse oximeters and a single piece of N95 material. An object of the present disclosure is to provide a package of packages each including two or more pulse oximeters and a single piece of N95 material. An object of the present disclosure is to provide a package including two pulse oximeters and a single piece of N95 material, where the shape of the package is naturally formed to its contents. An object of the present disclosure is to provide a package including two pulse oximeters and a single piece of N95 material, where the shape of the package is naturally formed to its contents and can be described as a sphere. An object of the present disclosure is to provide a package including two pulse oximeters and a single piece of N95 material, where the shape of the package is naturally formed to its contents and can be described as a cylinder. An object of the present disclosure is to provide a package including two pulse oximeters and a single piece of N95 material, where the shape of the package is naturally formed to its contents and can be described as a disc, planar, or as a rectangular physical segment.

If 85% of people hold an N95 type electroscopic material over their faces, our current population could experience herd immunity and the number of COVID-19 cases would fall, reasonably within three (3) to (5) incubation periods or approximately one (1) to three (3) months, if not significantly faster. To hold a swatch, section, or segment of N95 material to one's face in a moment is a maximally accessible action, far easier than trying to quickly don a mask or manage a 3D or sophisticated patterned 2D shape or form. Sophisticated patterned 2D shapes or forms generally include designs prescripting more than two layers normal to a plan view. Sophisticated patterned 2D shapes or forms generally include designs prescripting layers with seals that are close together. Close can be considered to be within 3-5 characteristic lengths, which may be considered to be one or more lengths along axes considerable in a plan view. Close can be considered to be within 3-5 characteristic lengths, which may be considered to be the bend radii of the design when folded, crimped, or crunched into a pocket.

An object of the present disclosure is to provide an article that with its simplicity and consideration for design, can be repeatedly stuffed into and pulled from a pocket and maintain its integrity.

An object of the present disclosure is to provide an article that can be separated to create two or more wearable masks. An object of the present disclosure is to provide an article that can be separated to create two or more nearly wearable masks, which with the attachment of securement attachments, become two or more wearable masks. An embodiment of the present disclosure is comprised of a first web and a second web that are heat sealed together by two seals approximately one inch apart in a first location. An embodiment of the present disclosure is comprised of a first web and a second web that are heat sealed together by two seals approximately one inch apart in a first location and again or in two more locations ranging between approximately 5 and 6 and approximately 7 and 9 inches from the first, or the second seals, respectively and repeatedly. In another, a repeatedly sealed web is further sealed or generally composed into a loop. A seal pattern that along its length provides the desired mask material sizing range and frequency for a community is an embodiment of the present disclosure. An embodiment of the present disclosure is comprised of a first web and a second web that are heat sealed together by at least two seals approximately one inch apart in a first location and again or in two more locations ranging between approximately 5 and 6 and approximately 7 and 9 inches from the first, or the second seals, respectively and repeatedly, and where further the first web and the second web are weakened between the seals. An embodiment of the present disclosure is comprised of a first web and a second web that are heat sealed together by at least two seals approximately one inch apart in a first location and again or in two more locations ranging between approximately 5 and 6 and approximately 7 and 9 inches from the first, or the second seals, respectively and repeatedly, and where further the first web and the second web are weakened between the seals with a perforation. An embodiment of the present disclosure is comprised of a first web and a second web that are heat sealed together by at least two seals approximately one inch apart in a first location and again or in two more locations ranging between approximately 5 and 6 and approximately 7 and 9 inches from the first, or the second seals, respectively and repeatedly, and where further the seals are intermittent. An embodiment of the present disclosure is comprised of a first web and a second web that are heat sealed together by at least two seals approximately one inch apart in a first location and again or in two more locations ranging between approximately 5 and 6 and approximately 7 and 9 inches from the first, or the second seals, respectively and repeatedly, and where further the seals are intermittent to the extent that each of the two seals described above is in-fact two sealed points for a total of four sealed points then repeated.

An object of the present disclosure is to optimize the rate of production and distribution of N95 materials by providing N95 materials to customers without the second manufacturing process. An object of the present disclosure is to provide a personal quantity of N95 material in a package that minimizes cost and maximizes ease-of-use, but primarily ease-of distribution. Described herein are articles for distributing, accepting, and using N95 material. Described herein are articles for distributing, accepting, and using N95 material, where the article is a group of useful articles, assembled into a kit.

One article of the present disclosure is comprised of a cover having a surface area and at least one article of electroscopic filter material enveloped within the surface area. An article of the present disclosure is comprised of a cover having a surface area and at least one article of electroscopic filter material enveloped within the surface area, where the surface area is continuous. An article of the present disclosure is comprised of a cover having a surface area and at least one article of electroscopic filter material enveloped within the surface area, where the surface area is considered to be continuous across a seal. An article of the present disclosure is comprised of a cover having a surface area and at least one article of electroscopic filter material enveloped within the surface area, where the surface area is considered to be continuous across a resealable seal. An article of the present disclosure is comprised of a cover having a surface area and at least one article of electroscopic filter material enveloped within the surface area. An article of the present disclosure is comprised of a cover having a surface area and at least one electroscopic filter material enveloped within the surface area, where the cover is low density polyethylene. An article of the present disclosure is comprised of a cover having a surface area and at least one article of electroscopic filter material enveloped within the surface area, where further the electroscopic filter material yields a non-zero reading on an electroscope. An article of the present disclosure is comprised of a cover having a surface area and at least one article of electroscopic filter material enveloped within the surface area, where further the electroscopic filter material yields a positive or negative reading on an electroscope.

One article of the present disclosure is comprised of a cover having a surface area and at least one article of electroscopic filter material enveloped within the surface area, and at least one indication for use also enveloped within the surface area. An article of the present disclosure is comprised of a cover having a surface area and at least one article of electroscopic filter material enveloped within the surface area and at least one indication for use printed on or applied to one of, one or more of, or all of the cover or the enveloped article or articles.

One article of the present disclosure is comprised of a cover having a surface area and at least one article of electroscopic filter material enveloped within the surface area, where the cover is comprised of a periphery and a seal and where the seal is located at the periphery and where further one or more layers of electroscopic filter material is sealed within the seal.

One article of the present disclosure is comprised of a cover having a surface area and at least one article of electroscopic filter material enveloped within the surface area, where size of the electroscopic filter material is similar to that of a blanket.

One article of the present disclosure is comprised of a cover having a surface area and at least one article of electroscopic filter material enveloped within the surface area, where size of the electroscopic filter material is similar to that of a scarf.

One article of the present disclosure is comprised of a cover having a surface area and at least one article of electroscopic filter material enveloped within the surface area, where size of the electroscopic filter material is similar to that of a handkerchief.

One article of the present disclosure is comprised of a cover having a surface area and at least one article of electroscopic filter material enveloped within the surface area, where size of the electroscopic filter material is similar to that of a towelette.

One article of the present disclosure is comprised of a cover having a surface area and at least one article of electroscopic filter material enveloped within the surface area, where size of the electroscopic filter material is similar to that of the area of a flat mask.

One article of the present disclosure is comprised of a cover having a surface area and at least one article of electroscopic filter material enveloped within the surface area, where the electroscopic filter material is joined with or laminated to at least a first comfort material.

One article of the present disclosure is comprised of a cover having a surface area and at least one article of electroscopic filter material enveloped within the surface area, where the electroscopic filter material is joined with or laminated to at least a first comfort material and a second decorative or weather material.

One article of the present disclosure is comprised of a cover having a surface area and at least one article of electroscopic filter material enveloped within the surface area, where the electroscopic filter material has two holes.

One article of the present disclosure is comprised of a cover having a surface area and at least one article of electroscopic filter material enveloped within the surface area, where the electroscopic filter material has two holes, one near each of two opposing ends.

One article of the present disclosure is comprised of a cover having a surface area and at least one article of electroscopic filter material enveloped within the surface area, where the cover is impermeable. One article of the present disclosure is comprised of a cover having a surface area and at least one article of electroscopic filter material enveloped within the surface area, where the cover is hermetically sealed. One article of the present disclosure is comprised of a cover having a surface area and at least one article of electroscopic filter material enveloped within the surface area, where the cover is comprised of a membrane with a porosity. One article of the present disclosure is comprised of a cover having a surface area and at least one article of electroscopic filter material enveloped within the surface area, where the cover is comprised of a membrane with a porosity and a gradient. One article of the present disclosure is comprised of a cover having a surface area and at least one article of electroscopic filter material enveloped within the surface area, where the cover is comprised of a membrane with a selective porosity and a selective gradient. One article of the present disclosure is comprised of a cover having a surface area and at least one article of electroscopic filter material enveloped within the surface area, where the cover is comprised of a membrane with a selective porosity and a selective gradient, and where the porosity is selective of size and the gradient can be measured by a measurement of concentration.

One article of the present disclosure is comprised of a cover having a surface area and five (5) folded articles of electroscopic filter material enveloped within the surface area. One article of the present disclosure is comprised of a cover having a surface area and five (5) folded articles of electroscopic filter material enveloped within the surface area, where the cover is low density polyethylene and the electroscopic filter material is made from polypropylene and alumina particles.

One article of the present disclosure is comprised of a cover having a surface area and five (5) folded articles of electroscopic filter material enveloped within the surface area, where the cover measures approximately eight (8) inches by eight (8) inches by one (1) inch.

One article of the present disclosure is comprised of a cover having a surface area and five (5) folded articles of electroscopic filter material enveloped within the surface area, where the cover measures approximately eight (8) inches by eight (8) inches by one (1) inch, and where each electroscopic filter material is approximately fourteen (14) inches by seven (7) inches, unfolded.

One article of the present disclosure is comprised of a cover having a surface area and five (5) folded articles of electroscopic filter material enveloped within the surface area, where the cover measures approximately eight (8) inches by eight (8) inches by one (1) inch, and where the material is sealed opposite the fold.

One article of the present disclosure is comprised of a cover having a surface area and five (5) folded articles of electroscopic filter material enveloped within the surface area, where the cover measures approximately eight (8) inches by eight (8) inches by one (1) inch, and where the material is continuous opposite the fold creating a tubular textile, non-woven, or otherwise flexible structure.

One article of the present disclosure is comprised of a cover having a surface area and one (1) folded articles of electroscopic filter material enveloped within the surface area, where the cover measures approximately five (5) inches by five (5) inches by three quarters (0.75) of an inch.

One article of the present disclosure is comprised of a cover having a surface area and one (1) folded articles of electroscopic filter material enveloped within the surface area, where the cover measures approximately five (5) inches by five (5) inches by three quarters (0.75) of an inch, and where the electroscopic filter material is approximately fourteen (14) inches by seven (7) inches, unfolded.

One article of the present disclosure is comprised of a cover having a surface area and one (1) folded article of electroscopic filter material enveloped within the surface area, where the cover measures approximately five (5) inches by five (5) inches by three quarters (0.75) of an inch, and where the material is sealed opposite one of the folds.

One article of the present disclosure is comprised of a cover having a surface area and one (1) folded article of electroscopic filter material enveloped within the surface area, where the cover measures approximately five (5) inches by five (5) inches by three quarters (0.75) of an inch, where the electroscopic filter material is approximately twenty (20) inches by eight (8) inches.

One article of the present disclosure is comprised of a cover having a surface area and one (1) folded article of electroscopic filter material enveloped within the surface area, where the cover measures approximately five (5) inches by five (5) inches by three quarters (0.75) of an inch, where the electroscopic filter material is approximately twenty (20) inches by eight (8) inches, and where the electronic filter material is stretchy.

One article of the present disclosure is comprised of a cover having a surface area and one (1) folded article of electroscopic filter material enveloped within the surface area, where the cover measures approximately five (5) inches by five (5) inches by three quarters (0.75) of an inch, where the electroscopic filter material is approximately twenty (20) inches by eight (8) inches, and where the electronic filter material is stretchy, and where the material is continuous opposite the fold creating a tubular textile, non-woven, or otherwise flexible structure.

One article of the present disclosure is comprised of a cover having a surface area and one (1) folded article of electroscopic filter material enveloped within the surface area, where the cover measures approximately five (5) inches by five (5) inches by three quarters (0.75) of an inch, where the electroscopic filter material is approximately twenty (20) inches by eight (8) inches in one state and twenty four (24) inches by eight (8) inches in another, and where the material is continuous opposite the fold creating a tubular textile, non-woven, or otherwise flexible structure.

One article of the present disclosure is comprised of a cover having a surface area and one (1) folded article of electroscopic filter material enveloped within the surface area, where the cover measures approximately five (5) inches by five (5) inches by three quarters (0.75) of an inch, where the electroscopic filter material is approximately twenty (20) inches by eight (8) inches in one state and twenty four (24) inches by eight (8) inches in another, and where the states are separate and the separation is created by bunch stitching the electroscopic material along the expandable axis.

One article of the present disclosure is comprised of a cover having a surface area and one (1) folded article of electroscopic filter material enveloped within the surface area, where the cover measures approximately five (5) inches by five (5) inches by three quarters (0.75) of an inch, where the electroscopic filter material is approximately twenty (20) inches by eight (8) inches in one state and twenty four (24) inches by eight (8) inches in another, and where the expandability of the material in at least one axis or bulk dimension or parameter minimizes the waste material generated by manufacturing.

One article of the present disclosure is comprised of a cover having a surface area and five (5) folded articles of electroscopic filter material enveloped within the surface area, where the cover measures approximately eight (8) inches by eight (8) inches by one (1) inch, where the article is produced by a distributed social network of producers, contributors, distributors, supporters, donors, customers, patrons, members, friends, relatives, parents, grand parents, aunt, uncles, siblings, children, grandchildren, volunteers, profiteers, material recyclers, or perfect strangers.

One article of the present disclosure is comprised of a cover having a surface area and five (5) folded articles of electroscopic filter material enveloped within the surface area, where the cover measures approximately eight (8) inches by eight (8) inches by one (1) inch, and where the electroscopic material has been trimmed, apparently while having been folded, such that the electroscopic material is no longer continuous across its surface, but is instead filled with symmetric or patterned voids that permit the corners to be omitted from folded forms, saving material, especially in consideration of specific use cases.

One article of the present disclosure is comprised of a package and a material, where the package is sealed or resealable around the material, and where the material is further comprised of a first web and a second web, where the first web and the second web are joined. One article of the present disclosure is comprised of a package and a material, where the package is sealed or resealable, and where the material is further comprised of a first web and a second web, where the first web and the second web are joined in a first location and a nearby location. One article of the present disclosure is comprised of a package and a material, where the package is sealed or resealable around the material, and where the material is further comprised of a first web and a second web, where the first web and the second web are joined in a first location and a nearby location and and at least one more time or at least one more pair of times in another first location and another nearby location. One article of the present disclosure is comprised of a package, a material, and at least one tensile element, where the package is sealed or resealable around the material and the tensile element, and where the material is further comprised of a first web and a second web, where the first web and the second web are joined. One article of the present disclosure is comprised of a package, a material, and at least one tensile element, where the package is sealed or resealable around the material and the tensile element, and where the material is further comprised of a first web and a second web, where the first web and the second web are joined, where the tensile element is an elastic. One article of the present disclosure is comprised of a package, a material, and at least one tensile element, where the package is sealed or resealable around the material and the tensile element, and where the material is further comprised of a first web and a second web, where the first web and the second web are joined, where the tensile element is a string. One article of the present disclosure is comprised of a package, a material, and at least one tensile element, where the package is sealed or resealable around the material and the tensile element, and where the material is further comprised of a first web and a second web, where the first web and the second web are joined, where the tensile element is removable or removed from the material or the package.

One object of the present disclosure is to provide people with an article that can be opened aseptically or as aseptically as possible. One article of the present disclosure is comprised of a cover that envelops articles, and is further comprised of hand sanitizer. One object of the present disclosure is to provide people with an article that can be opened aseptically or as aseptically as possible. One article of the present disclosure is comprised of a cover that envelops articles, and is further comprised of hand sanitizer within a pouch. where a pouch is a sealed enclosure. One article of the present disclosure is comprised of a cover that envelops articles, and is further comprised of hand sanitizer within a pouch, where the pouch is a sealed enclosure. One article of the present disclosure is comprised of a cover that envelops articles, and is further comprised of hand sanitizer within a pouch, where the pouch is composed of at least some of the surface area of the cover and additional material. One article of the present disclosure is comprised of a cover that envelops articles, and is further comprised of hand sanitizer within a pouch, where the pouch is composed of at least some of the surface area of the cover and a separate piece of material. One article of the present disclosure is comprised of a cover that envelops the articles, and is further comprised of hand sanitizer within a pouch, where the pouch is composed of at least some of the surface area of the cover and and additional material that extends from the cover. One article of the present disclosure is comprised of a cover that envelops the articles, and is further comprised of hand sanitizer within a pouch, where the pouch is composed of at least some of the surface area of the cover and and additional material that extends contiguously from the cover. One article of the present disclosure is comprised of a cover that envelops the articles, and is further comprised of hand sanitizer within a pouch, where the pouch is composed of at least some of the surface area of the cover and and additional material that continues from the cover.

One object of the present disclosure is to provide packaged articles or the articles individually, that are labeled. One object of the present disclosure is to provide packaged articles or articles that are labeled with instructions for use or public safety information. One object of the present disclosure is to provide packaged articles or articles that are labeled with a logo or graphic. One object of the present disclosure is to provide packaged articles or articles that are labeled with a revenue generating advertisement. One object of the present disclosure is to provide packaged articles or articles that are labeled in such a way that perpetuates a sustainable business model.

Optionally, the segments of the periphery that are adjacent to the fold of the 2D N95 Material may be sealed, creating both a simplistic mitt and an article ready for quick conversation into a mask. Optionally, the segments of the periphery that are perpendicular to the fold of the 2D N95 Material may be sealed, creating both a simplistic mitt and an article ready for quick conversation into a mask. In one embodiment, a simplistic mitt and article that is ready for quick conversion into a mask, is comprised of a periphery further comprised of first, second, third, and fourth periphery segments, where rotating clockwise around the periphery, the first periphery segment is comprised of a fold, the second periphery segment is sealed, the third periphery segment is neither sealed nor folded, but instead, open, and the fourth periphery segment is sealed. In one embodiment, a simplistic mitt and article that is ready for quick conversion into a mask, is comprised of a periphery further comprised of first, second, third, and fourth periphery segments, where rotating clockwise around the periphery, the first periphery segment is comprised of a fold, the second periphery segment is sealed, the third periphery segment is neither sealed nor folded, but instead, open, and the fourth periphery segment is sealed, and finally where the second and fourth periphery seals are discontinuous. In one embodiment, a simplistic mitt and article that is ready for quick conversion into a mask, is comprised of a periphery further comprised of first, second, third, and fourth periphery segments, where rotating clockwise around the periphery, the first periphery segment is comprised of a fold, the second periphery segment is sealed, the third periphery segment is neither sealed nor folded, but instead, open, and the fourth periphery segment is sealed, and finally where the second and fourth periphery seals are further comprised of two seals that terminate in such a way that they do not intersect with the fold, but instead provide a small opening for a cord, string, rope, or other tensile element to be threaded around each seal to create a retention mechanism for the article. In one embodiment, a simplistic mitt and article that is ready for quick conversion into a mask, is comprised of a periphery further comprised of first, second, third, and fourth periphery segments, where rotating clockwise around the periphery, the first periphery segment is comprised of a fold, the second periphery segment is sealed, the third periphery segment is neither sealed nor folded, but instead, open, and the fourth periphery segment is sealed, and where the second and fourth periphery seals are further comprised of two seals that terminate in such a way that they do not intersect with the fold, but instead provide a small opening for a cord, string, rope, or other tensile element to be threaded around each seal to create a retention mechanism for the article, and finally where the retention mechanism engages the ears. In one embodiment, a simplistic mitt and article that is ready for quick conversion into a mask, is comprised of a periphery further comprised of first, second, third, and fourth periphery segments, where rotating clockwise around the periphery, the first periphery segment is comprised of a fold, the second periphery segment is sealed, the third periphery segment is neither sealed nor folded, but instead, open, and the fourth periphery segment is sealed, and finally where the second and fourth periphery seals are further comprised of two seals that terminate in such a way that they do not intersect with the fold, but instead provide a small opening for a cord, string, rope, or other tensile element to be threaded around each seal to create a retention mechanism for the article, where the tensile element is a bungee cord or has similar properties to a bungee cord or other particularly elastic tensile element. Optionally, the tensile element can be threaded through gaps in the seals that have been applied to the second and fourth periphery segments, where the seals are intermittent. Optionally, the tensile element can be threaded through gaps in the seals applied to the second and fourth periphery segments, where the seals are intermittent, and further where at least one segment of one of the seals terminates at the fold of the first segment of the periphery that is folded.

Optionally, the components that constitute the N95 material may be combined and 3D printed onto a conveyor. Optionally, the components of the N95 material may be 3D printed onto a conveyor in a plurality of patterns to provide the optimum production process. Optionally, the components of the N95 material may be 3D printed onto a conveyor in a plurality of patterns to provide the optimum production process, where the patterns are 2D. Optionally, the components of the N95 material may be 3D printed onto a conveyor in a plurality of patterns to provide the optimum production process, where the patterns are 3D. Optionally, the components of the N95 material may be 3D printed onto a conveyor in a plurality of patterns to provide the optimum production process, where the patterns are 3D or higher in their order.

Optionally, the 2D N95 material may be patterned, preferably by a manufacturing process that can be applied during the first manufacturing process described herein, without slowing the production rate of the first manufacturing process. A patterned knurling process is one such process that could be applied to the first manufacturing process without slowing the first manufacturing process. Adding a patterned knurling process can stretch and thin sections of the 2D N95 material or stretch, shred, and puff the 2D N95 material. As such the patterned knurling process parameters can be adapted to create 3D geometries within or from the 2D N95 material that further continue to specialize the 2D N95 material or adapt the 2D N95 material for application. Alternatively, the process parameters of the melt-blow process that generally produces the non-woven material of the 2D N95 material manufacturing process, can be adapted to puff or thin the 2D N95 material. Outputs of the utilization of such processes that add properties or dimensions to the 2D N95 material and do not slow the first manufacturing process are included within the scope of the present disclosure. Optionally, the 2D N95 material may be imprinted or embossed with a popular repeating pattern.

Optionally, the 2D N95 material could be replaced with a bulk material with the appearance of a loft or fill, such as cotton or an emulating, open celled, or generally insulating synthetic. One embodiment of the present disclosure is comprised of a cover with a surface area and approximately one (1) ounce of electroscopic material enveloped within the surface area. Further, the bulk material could take a more axial or cylindrically extruded or melt blown form.

Please note, that the 2D N95 material described herein could be replaced with a material of a different filtration capability, such as N99 or even N90, and fall within the scope of the present disclosure. Please note, that the 2D N95 material described herein could be replaced with a material of a different filtration measure, such as N99 or even N90, depending on the parameters of the virus or pandemic against which the material is being utilized to protect. Please note, that the 2D N95 material described herein could be replaced with a material of a different material parameter or material property such as particulate filtration efficacy N99 or even N90, depending on the parameters of the virus or pandemic against which the material is being utilized to protect, by a signal is sent from a place in need to a place of manufacturing to adapt said material parameters to a need of a place in need.

The above summary is not intended to describe each illustrated embodiment or every implementation of the subject matter hereof. The figures and the detailed description that follow more particularly exemplify various embodiments.

### BRIEF DESCRIPTION OF FIGURES

Subject matter hereof may be more completely understood in consideration of the following detailed description of various embodiments in connection with the accompanying figures, in which:

FIGS. 1A and 1B are perspective views of packaged electroscopic filter material according to an embodiment.

FIG. 1C is a side view of the packaged electroscopic filter material of FIG. 1A.

FIG. 1D is a top-down view of the packaged electroscopic filter material of FIG. 1A.

FIG. 2A is a side view of a system for packaging electroscopic filter material according to an embodiment.

FIG. 2B is a front view of packaged electroscopic filter material according to an embodiment.

FIG. 2C is a side view of several individual packages of electroscopic filter material packaged together according to an embodiment.

FIG. 2D is a side view of several individual packages of electroscopic filter material stacked according to an embodiment.

FIGS. 2E and 2F are partial, side views of packaged electroscopic filter material according to embodiments.

FIGS. 2G is a side view of packaged electroscopic filter material according to an embodiment.

FIG. 3A is a side view of a system for packaging electroscopic filter material according to an embodiment.

FIG. 3B is a front view of packaged electroscopic filter material according to an embodiment.

FIG. 3C is a side view of several individual packages of electroscopic filter material packaged together according to an embodiment.

FIG. 3D is a side view of several individual packages of electroscopic filter material stacked according to an embodiment.

FIG. 4A is a side view of a system for packaging electroscopic filter material according to an embodiment.

FIG. 4B is side view of packaged electroscopic filter material according to an embodiment. FIG. 4C is a side view of a series of packaged electroscopic filter material according to an embodiment.

FIG. 4D is a front view of packaged electroscopic filter material according to an embodiment.

FIG. 4E is a side view of packaged electroscopic filter material according to an embodiment.

FIG. 5A is a side view of a system for packaging electroscopic filter material according to an embodiment.

FIG. 5B is a side view of packaged electroscopic filter material according to an embodiment.

FIG. 5C is a side view of packaged electroscopic filter material according to an embodiment.

While various embodiments are amenable to various modifications and alternative forms, specifics thereof have been shown by way of example in the drawings and will be described in detail. It should be understood, however, that the intention is not to limit the claimed disclosures to the particular embodiments described. On the contrary, the intention is to cover all modifications, equivalents, and alternatives falling within the spirit and scope of the subject matter as defined by the claims.

### DETAILED DESCRIPTION OF THE INVENTION

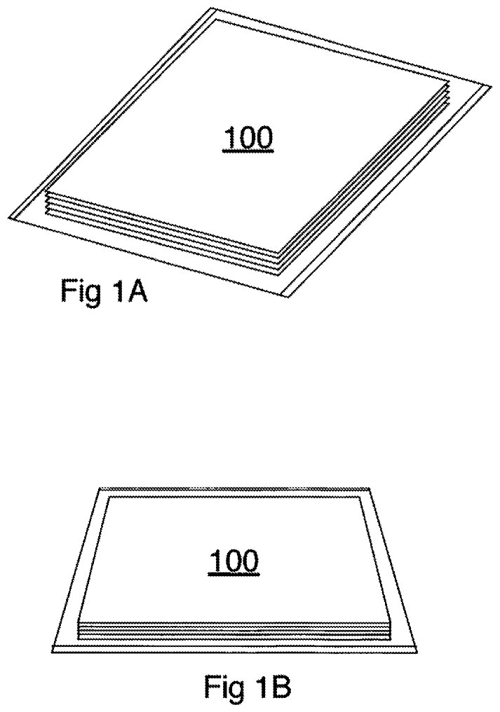

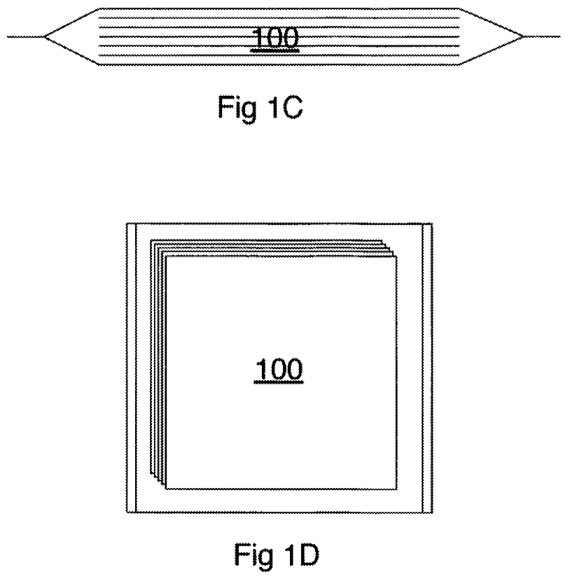

One article the present disclosure 100 is presented in FIGS. 1A through 1D. One article of the present disclosure 100 is comprised of a cover having a surface area and one (1) article of electroscopic filter material enveloped within the surface area. One article of the present disclosure 100 is comprised of a cover having a surface area and one (1) article of electroscopic filter material enveloped within the surface area, where the cover is low density polyethylene and the electroscopic filter material is made from polypropylene and alumina particles. One article of the present disclosure 100 is comprised of a cover having a surface area and one (1) folded article of electroscopic filter material enveloped within the surface area, where the cover measures approximately eight (8) inches by eight (8) inches by one (1) inch and where the electroscopic filter material measures sixty (60) inches by seven (7) inches, approximately. One article of the present disclosure 100 is comprised of a cover having a surface area and one (1) folded article of electroscopic filter material enveloped within the surface area, where the cover measures approximately eight (8) inches by eight (8) inches by one (1) inch and where the electroscopic filter material measures sixty (60) inches by seven (7) inches, approximately, and optionally where the filter material is joined together at its ends.

Described herein, is a package 100 of filter material, electroscopic material, N95 material, N99 material, or other important filtration material, that contains one and only one continuous, substantially unfenestrated, piece of said material, where the volume of the electroscopic material to be enveloped by the packaging is enveloped within a package that is spherically, cylindrically, planar, or otherwise naturally shaped to maximize the volume of the contents within the envelope, and where the article of the present disclosure draws its natural shape from the physical properties of the materials from which the contents and the envelope or package are composed and their processing together. Described herein, is a package 100 of filter material, electroscopic material, N95 material, N99 material, or other important filtration material, that contains one and only one continuous, substantially unfenestrated, piece of said material, where the volume of the electroscopic material to be enveloped by the packaging is enveloped within a package that is spherically, cylindrically, planar, or otherwise naturally shaped to maximize the volume of the contents within the envelope, and where the article of the present disclosure draws its natural shape from the physical properties of the materials from which the contents and the envelope or package are composed and their processing together, in relation to a seal or conduit of the material or the article as its representative.

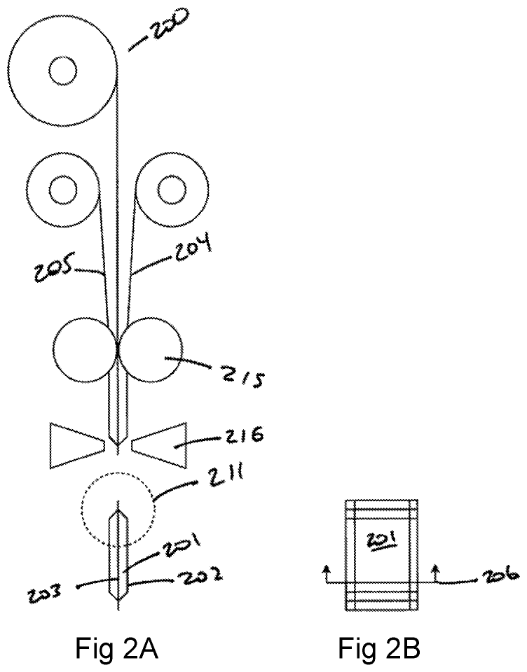

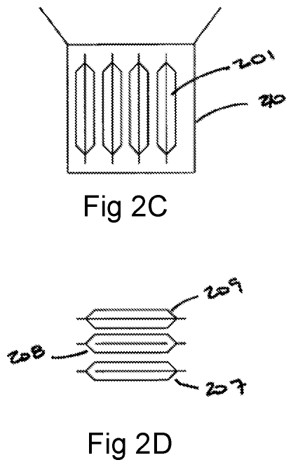

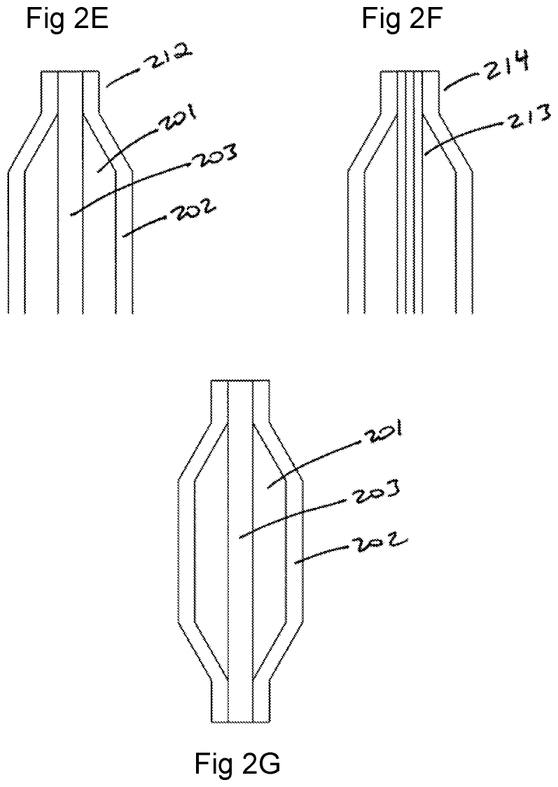

One manufacturing process 200 of the present disclosure is presented in FIG. 2A where the output is an article 201 comprised of a cover 202 having a surface area and at least one (1) article of electroscopic filter material 203 enveloped within the surface area, where further the filter material 203 is attached to the cover 202 in at least one location. One manufacturing process 200 of the present disclosure is presented in FIG. 2A where the output is an article 201 comprised of a cover 202 having a surface area and a periphery and at least one (1) article of electroscopic filter material 203 enveloped within the surface area, where further the filter material 203 is attached to the cover 202 in at least one location near the periphery. One manufacturing process 200 of the present disclosure is presented in FIG. 2A where the output is an article 201 comprised of a cover 202 having a surface area and a periphery and at least one (1) article of electroscopic filter material 203 enveloped within the surface area, where further the filter material 203 is heat sealed between cover webs 204 and 205 in at least one location near the periphery to form a hermetic seal. Optional embodiments of the present disclosure 207, 208, and 209 are presented in FIG. 2D and views of section perspective 206 as presented in FIG. 2B. An embodiment of the present disclosure is comprised of one or more packaged articles 201 and a box 210 as presented in FIG. 2C. A close-up of view of an embodiment of the present disclosure 201 within view scope 211 as presented in FIG. 2A is presented in FIG. 2E, is comprised of a cover 202 and at least one article of filter material 203 that is heat sealed to the cover 202 at at least one end 212. A close-up of view of an embodiment of the present disclosure is presented in FIG. 2F, is comprised of a cover 202 and three articles 213 of filter material 203 that is heat sealed to the cover 202 at atleast one end 214. FIG. 2G depicts a side view of an embodiment of the present disclosure.

In embodiments, manufacturing process 200 can be a web conversion process incorporating heat sealing roller nips 215 and heat sealing and cutting jaws 216.

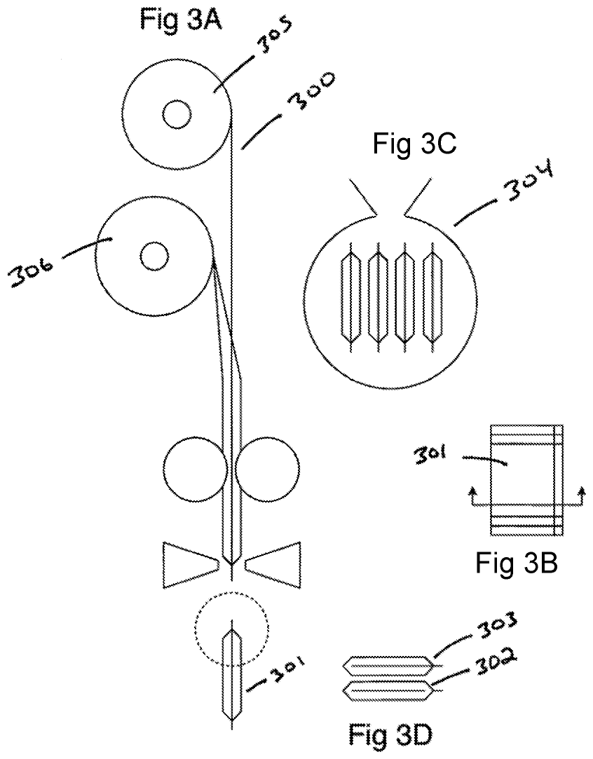

One manufacturing process 300 of the present disclosure is presented in FIG. 3A that manufactures an article 301 by combining a filter material 305 and a cover material 306 by folding the cover material 306 around the filter material 305 and heat sealing the cover material along one edge as shown by variations 302 and 303 in FIG. 3D. FIG. 3C depicts several articles packaged in a circular container with an opening. FIG. 3B depicts a front view of an article.

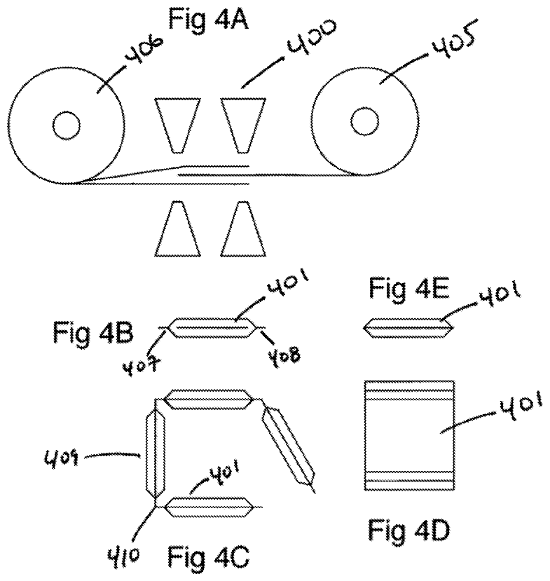

One manufacturing process 400 of the present disclosure is presented in FIG. 4A that manufactures an article 401 by combining a filter material 405 and a cover material 406 by inserting the filter material 405 within the cover material 406 and heat sealing the filter material 405 within the cover material 406 along two edges 407 and 408. An embodiment of the present disclosure is a roll 409 of manufactured articles 401 that are frangibly separated with perforations 410 as presented in FIG. 4C. FIGS. 4B, 4D, and 4E depict various embodiments of articles according to the present disclosure.

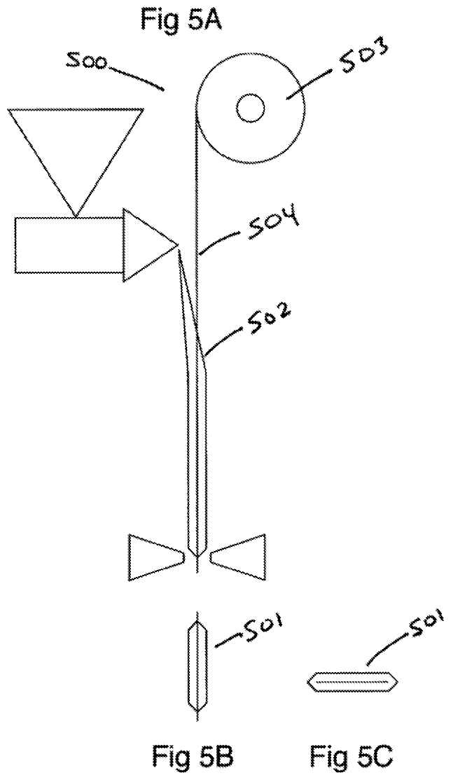

One manufacturing process 500 of the present disclosure is presented in FIG. 5A that manufactures an article 501 by extruding a cover material 502 around a filter material 504, where the filter material may be previously manufactured and accepted by the process from a roll 503. One manufacturing process 500 of the present disclosure is presented in FIG. 5A that manufactures an article 501 by co-extruding a cover material 502 around a filter material 504, and heat sealing and cutting or heat sealing and perforating the continuously assembled materials.

Various embodiments of systems, devices, and methods have been described herein. These embodiments are given only by way of example and are not intended to limit the scope of the claimed disclosures. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed disclosures.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for producing enveloped electroscopic filter material, comprising:
feeding, from a main spool, at least one sheet of electroscopic filter material in a first direction;
feeding, from a pair of spools, sheets of cover material in the first direction such that each spool feeds a sheet of cover material along a different side of the sheet electroscopic filter material;
sealing, via a pair of heat-sealing roller nips, the at least one sheet of electroscopic filter material and the sheets of cover material periodically together to form sealed portions;
cutting, via a cutting mechanism, each sealed portion to produce envelopes of electroscopic filter material, wherein the at least one sheet of electroscopic filter material extends to the outermost edges of each envelope such that each envelope has the same dimensions as the at least one sheet of electroscopic filter.

2. A system for producing enveloped electroscopic filter material, comprising:
a main spool configured to receive at least one sheet of electroscopic filter material and to feed the electroscopic filter material in a first direction;
a pair of spools configured to receive sheets of cover material and to feed the sheets of cover material in the first direction such that each spool feeds cover material along a different side of the electroscopic filter material;
a pair of heat sealing roller nips configured to periodically seal the at least one sheet of electroscopic filter material and the sheets of cover material to form sealed portions;
a cutting mechanism configured to cut each sealed portion to produce envelopes of electroscopic filter material, wherein the at least one sheet of electroscopic filter material extends to the outermost edges of each envelope such that each envelope comprises has the same dimensions as the at least one sheet of electroscopic filter material.

3. The system of claim 2, wherein the sheets of cover material comprise plastic.

4. An article for storing electroscopic filter material comprising:
at least one sheet of electroscopic filter material;
a first sheet of cover material covering a first side of the at least one sheet of electroscopic filter material;
a second sheet of cover material covering a second side of the at least one sheet of electroscopic filter material,
wherein the at least one sheet of electroscopic filter material, the first sheet of cover material, and the second sheet of cover material each extend to the perimeter of the article and the perimeter of the article is heat sealed.
